(19) United States
(12) Patent Application Publication
(10) Pub. No.: US 2022/0269269 A1
(43) Pub. Date: Aug. 25, 2022

(54) MOBILE ROBOT PLATFORM SYSTEM AND OPERATION METHOD THEREFOR

(71) Applicant: ROBOTIS CO.,LTD., Seoul (KR)

(72) Inventors: Byoung Soo KIM, Seoul (KR); In Yong HA, Seoul (KR); Woo Sik YANG, Seoul (KR); Yoon Seok PYO, Gimpo-si, Gyeonggi-do (KR)

(73) Assignee: ROBOTIS CO.,LTD., Seoul (KR)

(21) Appl. No.: 17/627,006

(22) PCT Filed: Jun. 25, 2020
(86) PCT No.: PCT/KR2020/008259

§ 371 Date: Jan. 13, 2022

(30) Foreign Application Priority Data
Jul. 15, 2019 (KR) 10-2019-0084919

(51) Int. Cl. G05D 1/00; G06N 20/00

(52) U.S. Cl. CPC G05D 1/0088; G05D 1/0011; G06N 20/00

(57) ABSTRACT

A mobile robot platform system evolves autonomous driving ability of a mobile robot through reinforcement learning in various environments. The mobile robot platform system includes a remote control unit configured to perform remote control of the mobile robot according to its purpose of use; an autonomous driving unit configured to autonomously drive the mobile robot in an autonomous driving section based on a preset criterion; a data collection unit configured to collect data for driving of the mobile robot; a learning unit configured to train the mobile robot using reinforcement learning data including the collected data; and a determination unit configured to determine a remote control section and the autonomous driving section based on a level of the training when the mobile robot moves to a corresponding destination.

### CROSS-REFERENCE TO PRIOR APPLICATIONS

This application is a National Stage patent Application of PCT International Patent Application No. PCT/KR2020/008259 (filed on Jun. 25, 2020) under 35 U.S.C. § 371, which claims priority to Korean Patent Application No. 10-2019-0084919 (filed on Jul. 15, 2019), which are all hereby incorporated by reference in their entirety.

### BACKGROUND

The present disclosure relates to a mobile robot platform system and an operation method therefor, and more particularly, to a mobile robot platform system capable of performing safe autonomous driving and movement of a mobile robot based on reinforcement learning according to its purpose of use.

As new technologies of the 4th industrial revolution (artificial intelligence, 5G, etc.) are grafted onto robots, the smartization of robots is advancing rapidly, and the field of application is rapidly expanding. In particular, various types of robots, such as 5G-based cloud robots and delivery robots, are emerging, and an unprecedented robot boom is forming as investments and M&As in the robot industry are expanding worldwide.

Meanwhile, interest in mobile robots for various purposes to solve problems such as rising labor costs in labor-intensive industries is growing.

Background art of the present disclosure is disclosed in Korean Patent Registration No. 10-0914904.

### SUMMARY

The present disclosure provides a mobile robot platform system and an operating method therefor in which a mobile robot can safely move through remote control and autonomous driving while collecting sufficient reinforcement learning data according to its purpose of use.

In addition, the present disclosure provides a mobile robot platform system and an operating method therefor in which autonomous driving ability of a mobile robot through reinforcement learning evolves in various environments according to its purpose of use.

According to one aspect of the present disclosure, a mobile robot platform system is provided.

A mobile robot platform system according to one embodiment of the present disclosure includes: a remote control unit for performing remote control of a mobile robot according to its purpose of use; an autonomous driving unit for autonomously driving the mobile robot in an autonomous driving section based on a preset criterion; and a data collection unit that collects data for driving the mobile robot; a learning unit for training the mobile robot using reinforcement learning data including the collected data; and a determination unit for determining a remote control section and the autonomous driving section based on a level of the training of the mobile robot when the mobile robot moves to a destination.

According to one embodiment of the present disclosure, the mobile robot platform system can perform remote control and autonomous driving to allow the mobile robot to safely move while collecting sufficient reinforcement learning data according to its purpose of use.

According to one embodiment of the present disclosure, in the mobile robot platform system, autonomous driving ability of the mobile robot through reinforcement learning can evolve in various environments according to its purpose of use.

### BRIEF DESCRIPTION OF THE DRAWINGS

FIGS. 1 and 2 are diagrams for explaining a mobile robot platform system according to one embodiment of the present disclosure.

FIG. 3 is a view for explaining a method of operating a mobile robot platform according to one embodiment of the present disclosure.

FIGS. 4 to 6 show examples of the method of operating the mobile robot platform according to one embodiment of the present disclosure.

### DETAILED DESCRIPTION

The present disclosure may have various changes and may have various embodiments, specific embodiments are illustrated in the drawings and will be described in detail through detailed description. However, it is not intended to limit the present disclosure to the specific embodiments, and the present disclosure should be understood to include all modifications, equivalents, and substitutes included in the spirit and scope of the present disclosure. In describing the present disclosure, if it is determined that a detailed description of a related known technology may unnecessarily obscure the gist of the present disclosure, the detailed description thereof will be omitted. Also, the singular terms used in the specification and claims are to be construed to mean “one or more” in general, unless stated otherwise.

Hereinafter, embodiments of the present disclosure will be described in detail with reference to the accompanying drawings. In the description with reference to the accompanying drawings, the same or corresponding components are given the same reference numerals, and the redundant description thereof will be omitted.

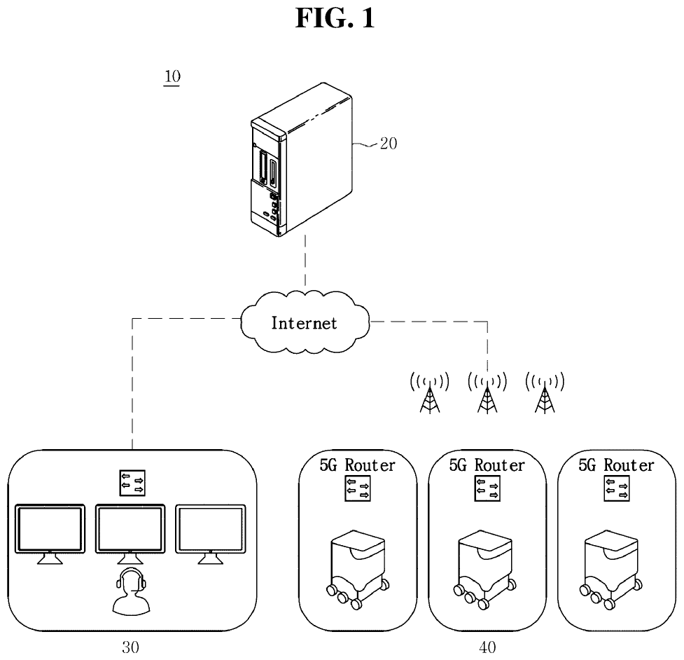

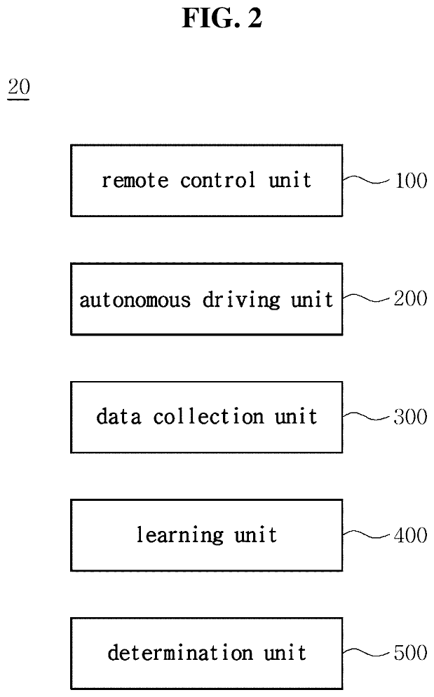

FIGS. 1 and 2 are diagrams for explaining a mobile robot platform system according to one embodiment of the present disclosure.

Referring to FIG. 1, a mobile robot platform system 10 includes an optimization server 20, a remote monitoring and control device 30, and a mobile robot 40.

The mobile robot platform system 10 gradually reinforces the mobile robot 40 by performing remote control and autonomous driving of the mobile robot 40 in parallel. The mobile robot platform system 10 collects learning data for reinforcement learning of the mobile robot 40 while remotely controlling the mobile robot 40. The mobile robot platform system 10 sets a remote control section and an autonomous driving section according to preset criteria, and gradually reduces the remote control section and increases the autonomous driving section according to the progress of reinforcement learning based on the collected learning data to finally minimize the remote control section.

The mobile robot platform system 10 performs remote control and autonomous driving of the mobile robot 40 regardless of indoors and outdoors for various purposes such as product delivery, food delivery, road guidance, and garbage collection to optimize the mobile robot 40 according to its purpose of use.

The optimization server 20 performs reinforcement learning on the mobile robot 40 to optimize the mobile robot 40 according to its purpose of use. The optimization server 20 performs remote control of the mobile robot 40 according to its purpose of use. The optimization server 20 collects learning data necessary for autonomous driving while performing remote control. The optimization server 20 may set the autonomous driving section to autonomously drive the mobile robot 40 while collecting learning data based on the preset criterion. Here, the preset criterion may include at least one of driving difficulty level, safety level, and autonomous driving success rate. The optimization server 20 uses the collected learning data to perform reinforcement learning of the mobile robot 40 to correspond to its purpose of use. The optimization server 20 may achieve the purpose of using the mobile robot 40 by performing reinforcement learning until the autonomous driving section and autonomous operation are maximized.

Referring to FIG. 2, the optimization server 20 includes a remote control unit 100, an autonomous driving unit 200, a data collection unit 300, a learning unit 400, and a determination unit 500.

The remote control unit 100 performs remote control of the mobile robot 40 according to its purpose of use. The remote control unit 100 may request the remote monitoring and control device 30 to be described later to remotely control the mobile robot 40 in a preset remote control section

The autonomous driving unit 200 autonomously drives the mobile robot 40 in the autonomous driving section based on the preset criterion. Here, the autonomous driving section may be gradually expanded according to the level of reinforcement learning.

The data collection unit 300 collects data for the driving of the mobile robot 40. The data collection unit 300 may include at least one of sensor data, motion data such as translation, rotation and stop of the mobile robot 40, movement data such as movement speed and position of the mobile robot, and control information of the mobile robot 40, which are collected when the mobile robot 40 travels. Here, the sensor data may include at least one of camera sensor data, LiDAR sensor data, ultrasonic sensor data, ToF (Time of Flight) sensor data, inertial sensor data, microphone sensor data, GPS sensor data, current sensor data, and temperature sensor data. Specifically, the camera sensor data may include at least one of surrounding 3D information, dynamic obstacle information (people, animals, vehicles, strollers, etc.), static obstacle information (buildings, signboards, trees, trash cans, etc.), road information (roadways, sidewalks, bicycle paths, road lanes, intersections, roundabouts, etc.), sign recognition information (speed limit signs, crosswalk signs, driveway signs, etc.), weather information (illuminance, rain, snow, fog, etc.), information on the available routes for the mobile robot in a sidewalk, and information on the available routes for the mobile robot in a crosswalk. The LiDAR sensor data or the ToF sensor data may be collected using at least one of appearance information and distance measurement information on surrounding buildings. The ultrasonic sensor data includes obstacle information during the driving of the mobile robot. The inertial sensor data includes posture information of the mobile robot during the driving of the mobile robot. The microphone sensor data includes ambient noise information. The GPS sensor data includes location information of the mobile robot. The current sensor data includes power consumption information of the mobile robot. The temperature sensor data may include at least one of external temperature information and internal temperature information of the mobile robot.

The data collection unit 300 may collect image information as online information, and may also simultaneously collect driving information for each situation and various sensor information. In addition, the data collection unit 300 may collect and manage data by connecting not only image information, but also mobile robot control information and sensor information in a specific situation.

The data collection unit 300 may store in advance offline information necessary for the driving of the mobile robot 40. Here, the offline information necessary for driving may include at least one of map data, surrounding environment data, weather data, and event data for a driving route. Further, the data collection unit 300 may store in advance data required for reinforcement learning for autonomous driving.

The learning unit 400 generates reinforcement learning data using the data collected or stored in advance. Specifically, the learning unit 400 configures driving environment state learning data including at least one of road state data, mobile robot position data, and other vehicle or obstacle information on the road using the collected data. The learning unit 400 sets operation learning data of the mobile robot 40 such as translation, rotation, and stop corresponding to the configured driving environment state data. In addition, the learning unit 400 generates learning data of fast and safe movement which avoid collisions and maximizes fuel efficiency. The learning unit 400 generates the most effective movement model, that is, driving learning data, through the continuously repeated learning process. The learning unit 400 may generate both driving learning data of the mobile robot 40 through remote control and driving learning data of the mobile robot 40 through autonomous driving.

The learning unit 400 performs reinforcement learning for autonomous driving on the mobile robot 40 using the generated driving learning data. Here, reinforcement learning is learning through interaction with the surrounding environment. The learning unit 400 may preferentially use driving learning data acquired during the remote control. Specifically, the learning unit 400 allows the mobile robot 40 to drive autonomously in a normal state, but the mobile robot is remotely controlled by the remote monitoring and control device 30 when driving in a dangerous area of high driving difficulty, such as a new geographic feature area with a low level of learning, a crosswalk and a densely populated area, and information obtained at this time may be given priority. Further, the learning unit 400 may preferentially use new learning data. The learning unit 400 may arbitrarily adjust the learning priority, for example, by giving weight to new data when the new data occupy a certain portion in comparison with existing data. In the learning unit 400, the motion learning data corresponding to the purpose of using the mobile robot 40 may also be obtained by performing reinforcement learning on the mobile robot 40 in a manner similar to the driving learning data.

The determination unit 500 determines the remote control section and the autonomous driving section when the mobile robot 40 moves to a corresponding destination. Here, the remote control section is a section in which the mobile robot 40 is remotely controlled through the remote monitoring and control device 30, and the autonomous driving section is a section in which the mobile robot 40 autonomously drives using an optimal movement model obtained through reinforcement learning. The determination unit 500 calculates driving difficulty level, safety level and autonomous driving success rate in the moving area. The driving difficulty may be calculated based on path complexity information, geographic feature information, and path information including at least one of a straight driving section, a sidewalk section, and a crosswalk section. The safety level may be calculated using at least one of floating population information, obstacle information, event information, and collision possibility information. The autonomous driving success rate may be calculated using the success rate accumulated during the application of the autonomous driving. The determination unit 500 may set the driving difficulty level or the safety level to be high, for example, in a crosswalk, an obstacle dense area, and a floating population dense area. The determination unit 500 may control the mobile robot by designating the remote control section when the driving difficulty level, the safety level or the autonomous driving success rate is out of a preset range. The determination unit 500 may, for example, allow the remote monitoring and control device 30 to control the mobile robot when a new geographic feature or a new place is recognized even in the autonomous driving section.

The remote monitoring and control device 30 remotely monitors and controls the mobile robot 40. The remote monitoring and control device 30 moves the mobile robot 40 by transmitting a value input by a remote controller to the mobile robot 40 in real time. The remote monitoring and control device 30 may include a display device for displaying surrounding image data acquired by the mobile robot 40. Through the display device of the remote monitoring and control device 30, the remote controller may recognize the surrounding environment of the mobile robot 40 and appropriately control the mobile robot 40.

The mobile robot 40 moves based on its purpose of use, and performs an operation. The mobile robot 40 is described by using an example of a robot that travels on the surface of the ground, but the present disclosure is not limited thereto, and the mobile robot 40 may include any type of mobile robot that remotely or autonomously travels in the sky or underwater, such as a drone, an underwater drone, etc.

The mobile robot 40 is connected through communication with the optimization server 20 and the remote monitoring and control device 30 to be controlled and monitor the surrounding environment. The mobile robot 40 collects data for remote driving or autonomous driving. The mobile robot 40 may collect at least one of various sensor data, motion data such as translation, rotation, and stop of the mobile robot 40, movement data such as movement speed and position of the mobile robot, and control information of the mobile robot 40 to transmit them to the optimization server 40. Here, the sensor data may include at least one of camera sensor data, LiDAR sensor data, ultrasonic sensor data, ToF (Time of Flight) sensor data, inertial sensor data, microphone sensor data, GPS sensor data, current sensor data, and temperature sensor data. Specifically, the camera sensor data may include at least one of surrounding 3D information, dynamic obstacle information (people, animals, vehicles, strollers, etc.), static obstacle information (buildings, signboards, trees, trash cans, etc.), road information (roadways, sidewalks, bicycle paths, road lanes, intersections, roundabouts, etc.), sign recognition information (speed limit signs, crosswalk signs, driveway signs, etc.), weather information (illuminance, rain, snow, fog, etc.), information on the available routes for the mobile robot in a sidewalk and, information on the available routes for the mobile robot in a crosswalk. The LiDAR sensor data or The ToF sensor data may be collected by using at least one of appearance information and distance measurement information on surrounding buildings. The ultrasonic sensor data includes obstacle information during the driving of the mobile robot. The inertial sensor data includes posture information of the mobile robot during the driving of the mobile robot. The microphone sensor data includes ambient noise information. The GPS sensor data includes location information of the mobile robot. The current sensor data includes power consumption information of the mobile robot. The temperature sensor data may include at least one of external temperature information and internal temperature information of the mobile robot.

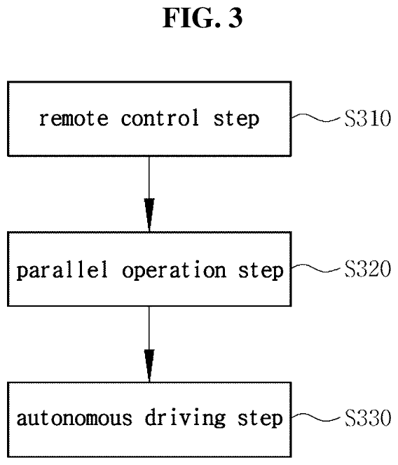

FIG. 3 is a view for explaining a method of operating the mobile robot system according to one embodiment of the present disclosure.

Referring to FIG. 3, the method of operating the mobile robot platform system 10 includes a remote control step S310, a parallel operation step S320, and an autonomous driving step S330. During the above steps, the mobile robot platform system 10 uses a reinforcement learning model and moves to the autonomous driving step while gradually lowers the dependence on remote control.

In step S310, the mobile robot platform system 10 performs remote control of the mobile robot 40. The mobile robot platform system 10 collects at least one of driving learning data and motion learning data corresponding to the purpose of using the mobile robot 40. For example, when the mobile robot platform system 10 intends to use the mobile robot 40 for navigation purpose, the mobile robot platform system 10 may collect driving learning data while performing remote control on the mobile robot 40 so that the mobile robot 40 moves in an efficient and safe route from a start position to a destination position. In the mobile robot platform system 10, a plurality of remote controllers may be simultaneously involved for one mobile robot 40 in the remote control step. Here, the plurality of remote controllers may perform remote control smoothly for different assigned tasks and collect driving learning data. The driving data collected by the mobile robot platform system 10 may include image information and other sensor information simultaneously collected through a variety of sensors coupled to the mobile robot 40, and remote control information in a corresponding situation. Accordingly, situation-related learning is possible without depending on the relationship with a country and region in which the robot is driven and the purpose of using the robot.

In step S320, when meaningful driving data is collected through the remote control step, the mobile robot platform system 10 divides a driving section into a remote control section and an autonomous driving section to perform remote control driving and autonomous driving in parallel. The mobile robot platform system 10 still uses the remote control of the remote controller in the remote control section, and allows the mobile robot 40 to autonomously drive and act using the data extracted by performing reinforcement learning with the driving data collected by the mobile robot 40 in the autonomous section. The mobile robot platform system 10 may set the autonomous driving section based on at least one of driving difficulty level, safety level, and autonomous driving success rate. For example, the mobile robot platform system 10 may start to set the autonomous driving section for a sidewalk section and a straight driving section, and gradually expand the autonomous driving section to other sections. In the mobile robot platform system 10, as reinforcement learning progresses, the remote control section of the mobile robot 40 may decrease and the autonomous driving section may increase.

In step S330, the mobile robot platform system 10 minimizes remote control and manages autonomous driving of a plurality of mobile robots 40. The mobile robot platform system 10 monitors and manages the plurality of mobile robots 40, and when the safety level is low due to a prescribed situation such as a newly added route section or an unexpected accident, may remotely control the mobile robot 40 even in the autonomous driving section.

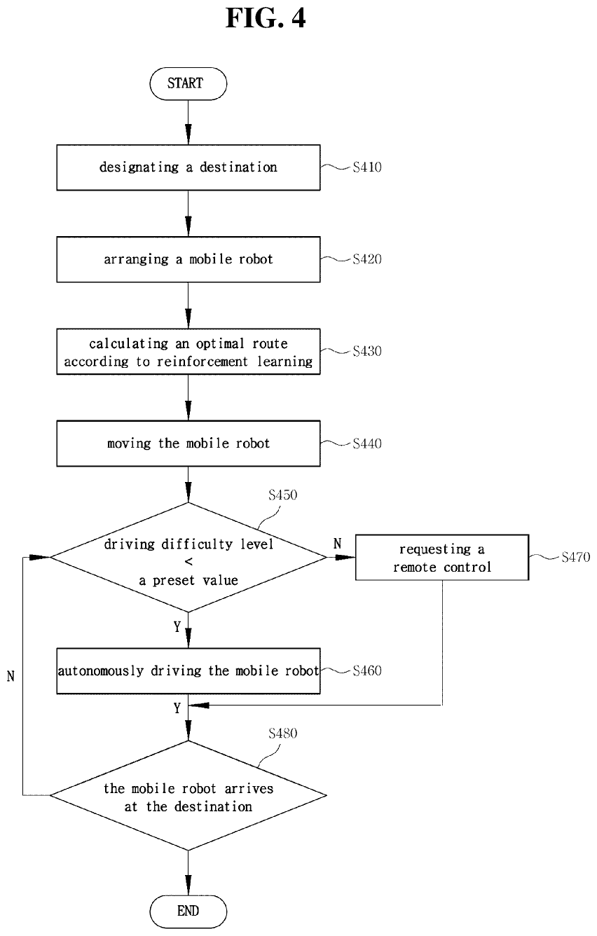

FIGS. 4 to 6 show examples of the method of operating the mobile robot platform according to one embodiment of the present disclosure.

Referring to FIG. 4, when the mobile robot 40 is used for product delivery, the mobile robot platform system 10 may determine the remote control section and the autonomous driving section based on at least one of driving difficulty level, safety level, and autonomous driving success rate.

In step S410, the mobile robot platform system 10 designates a destination.

In step S420, the mobile robot platform system 10 arranges a mobile robot 40 close to the destination or suitable for the requested operation. For example, a mobile robot 40 near the destination which has completed its task or a mobile robot 40 in a robot waiting area is arranged.

In step S430, the mobile robot platform system 10 calculates driving data as an optimal route according to reinforcement learning from the designated location of the mobile robot 40 to the destination.

In step S440, the mobile robot platform system 10 moves the mobile robot 40 according to the optimal route driving data.

In step S450, the mobile robot platform system 10 compares at least one of the driving difficulty level, safety level, and autonomous driving success rate of the moving section with a preset criterion.

In step S460, in the mobile robot platform system 10, if at least one of the driving difficulty level, the safety level, and the autonomous driving success rate is lower than the preset criterion, the mobile robot autonomously drives according to the autonomous driving data.

In step S480, the operation of the mobile robot platform system 10 is terminated when the mobile robot 40 arrives at the destination, and the mobile robot platform system 10 stands by an instruction of a new destination and operation.

In step S470, the mobile robot platform system 10 requests a remote control when at least one of the driving difficulty level, the safety level, and the autonomous driving success rate is higher than the preset criterion. The mobile robot platform system 10 may also request a remote control even when a new geographic feature is discovered.

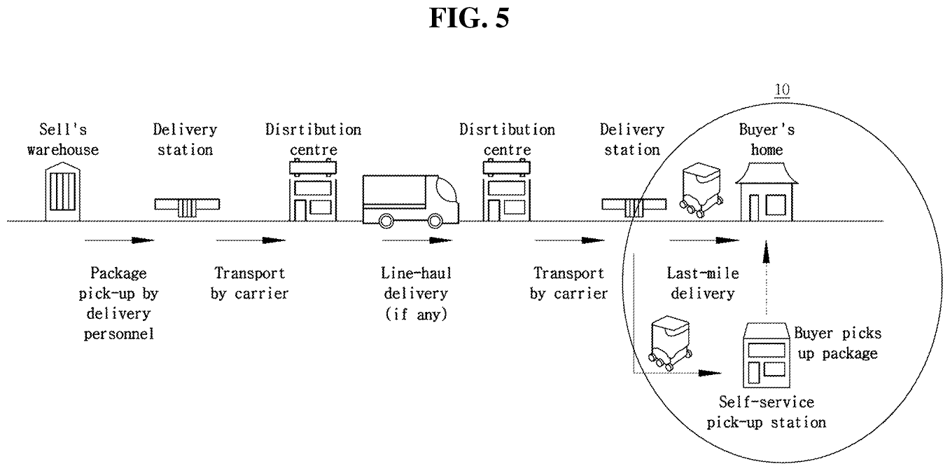

Referring to FIG. 5, the mobile robot platform system 10 may perform reinforcement learning for the purpose of a short-distance product delivery service. The mobile robot platform system 10 may be used in the last mile (delivery from warehouse to consumer) stage of logistics delivery.

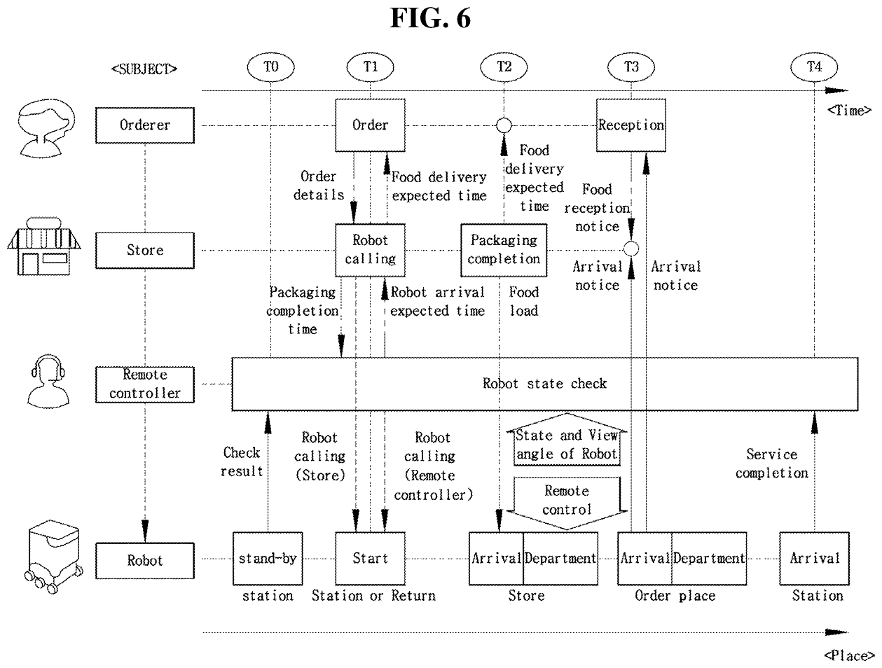

Referring to FIG. 6, the mobile robot platform system 10 may perform reinforcement learning for the purpose of a short-distance food delivery service. The mobile robot platform system 10 checks order information delivered to a store and designates a mobile robot 40. The mobile robot platform system 10 calculates the most efficient route to a destination. In the mobile robot platform system 10, the designated mobile robot 40 visits the store in the packaging completion time of the product, and receives the ordered product. In the mobile robot platform system 10, the mobile robot 40 carries out delivery to the destination requested by an orderer after loading the ordered product. The mobile robot platform system 10 allows the mobile robot to move along the most efficient and optimal path to the destination. The mobile robot platform system 10 requests the remote monitoring and control device 30 to remotely control the mobile robot 40 in a section in the moving paths in which at least one of the driving difficulty level, the safety level and the autonomous driving success rate is higher than the preset criterion. When the delivery is completed, the mobile robot platform system 10 calculates a return path, and the mobile robot 40 returns along the optimal return path. At this time, the mobile robot platform system 10 may return the mobile robot 40 or move the mobile robot 40 to a store for the next delivery. The mobile robot platform system 10 calculates the optimal movement path and appropriate behavior based on the reinforcement learning model and the sensor data collected in real time.

The above-described mobile robot platform system operating method may be implemented as a computer readable code in a computer readable recording medium. The computer-readable recording medium may be, for example, a portable recording medium (CD, DVD, Blu-ray disk, USB storage device, portable hard disk) or a fixed recording medium (ROM, RAM, computer-equipped hard disk). The computer program recorded in the computer-readable recording medium may be transmitted to another computing device through a network such as the Internet and installed in the another computing device to be used in the another computing device.

In the above, even though all the components constituting the embodiment of the present disclosure are described as being combined or operating in combination, the present disclosure is not necessarily limited to this embodiment. That is, within the scope of the object of the present disclosure, all the components may operate by selectively combining one or more.

Although operations are shown in a particular order in the drawings, it is not to be understood that the operations should be performed in the specific order or sequential order shown, or that all illustrated operations should be performed to obtain a desired result. In certain circumstances, multitasking and parallel processing may be advantageous. Moreover, the separation of the various components in the embodiments described above should not be construed as necessarily requiring such separation, and it should be understood that the program components and systems described may generally be integrated together into a single software product or packaged into multiple software products.

In the above, even though all the components constituting the embodiment of the present disclosure are described as being combined or operating in combination, the present disclosure is not necessarily limited to this embodiment. That is, within the scope of the present invention, all the components may operate by selectively combining one or more thereof.

In the above, the present disclosure has been focused on the embodiments thereof. Those of ordinary skill in the art to which the present disclosure pertains will understand that the present disclosure can be implemented in a modified form without departing from the essential characteristics of the present disclosure. Therefore, the disclosed embodiments should be considered in an illustrative sense rather than a restrictive sense. The scope of the present disclosure is indicated in the claims rather than the foregoing description, and all differences within the scope equivalent to the present disclosure should be construed as being included in the present disclosure.

The present disclosure relates to a mobile robot platform system and an operating method therefor, and can be applied in various industrial fields and environments since autonomous driving ability of a mobile robot evolves through reinforcement learning.

1. A mobile robot platform system which evolves autonomous driving ability of a mobile robot through reinforcement learning in various environments, the system comprising:
a remote control unit configured to perform remote control of the mobile robot according to its purpose of use;
an autonomous driving unit configured to autonomously drive the mobile robot in an autonomous driving section based on a preset criterion;
a data collection unit configured to collect data for driving of the mobile robot;
a learning unit configured to train the mobile robot using reinforcement learning data including the collected data; and
a determination unit configured to determine a remote control section and the autonomous driving section based on a level of the training when the mobile robot moves to a corresponding destination.

2. The mobile robot platform system of claim 1, wherein the preset criteria includes at least one of driving difficulty level, safety level, or autonomous driving success rate.

3. The mobile robot platform system of claim 2, wherein the driving difficulty level is calculated based on path complexity information, geographic feature information, and path information including at least one of a straight driving section, a sidewalk section, and a crosswalk section.

4. The mobile robot platform system of claim 2, wherein the safety level is calculated using at least one of floating population information, obstacle information, event information, and collision possibility information.

5. The mobile robot platform system of claim 1, wherein the determination unit changes the autonomous driving section to the remote control section when recognizing a new geographic feature or a new place even in the autonomous driving section.
